(19) United States
(12) Patent Application Publication
(10) Pub. No.: US 2016/0018543 A1
(43) Pub. Date: Jan. 21, 2016

(54) QUALITY CHECK OF COMPRESSED DATA SAMPLING INTERPOLATION FOR SEISMIC INFORMATION

(71) Applicant: WESTERNGECO L.L.C., Houston, TX (US)

(72) Inventor: Ralf Ferber, Horsham (DE)

(21) Appl. No.: 14/337,200

(22) Filed: Jul. 21, 2014

(51) Int. Cl. G01V 1/30

(52) U.S. Cl. CPC G01V 1/30; G01V 2210/60

(57) ABSTRACT

Computing systems, methods, and computer-readable media for improving data quality are disclosed. In some embodiments, a method of quality checking seismic interpolation data is provided, where the method includes obtaining first measured seismic data acquired by a first plurality of seismic sensors; obtaining second measured seismic data acquired by a second plurality of seismic sensors; interpolating, from the first measured seismic data, respective seismic data values at locations corresponding to respective sensors in the second plurality of seismic sensors; calculating a plurality of interpolation differences, where respective interpolation differences are calculated as numerical differences between respective interpolated seismic data values corresponding to respective sensor locations in the second plurality of sensors and respective measured seismic data values corresponding to respective sensors in the first plurality of sensors; and calculating an average interpolation difference using at least the plurality of interpolation differences.

### BACKGROUND

Seismic survey data acquisition may include using a number of seismic sensors in order to ultimately obtain an image of a survey area for purposes of identifying subterranean geological formations. Analysis of the representation may reveal probable locations of hydrocarbon deposits in subterranean geological formations. Because the seismic sensors are placed at discrete locations, seismic surveys may interpolate seismic data values at locations lacking sensors. Accordingly, there is a need to quality check interpolated data values in the context of seismic surveys.

### SUMMARY

In accordance with some embodiments, a method of quality checking seismic interpolation data is performed that includes obtaining first measured seismic data acquired by a first plurality of seismic sensors; obtaining second measured seismic data acquired by a second plurality of seismic sensors; interpolating, from the first measured seismic data, respective seismic data values at locations corresponding to respective sensors in the second plurality of seismic sensors; calculating a plurality of interpolation differences, where respective interpolation differences are calculated as numerical differences between respective interpolated seismic data values corresponding to respective sensor locations in the second plurality of sensors and respective measured seismic data values corresponding to respective sensors in the first plurality of sensors; and calculating an average interpolation difference using at least the plurality of interpolation differences.

Embodiments of the disclosure may also provide a computing system including one or more processors, and a memory system including one or more computer-readable media storing instructions thereon that, when executed by the one or more processors, are configured to cause the computing system to perform operations. The operations may include obtaining first measured seismic data acquired by a first plurality of seismic sensors; obtaining second measured seismic data acquired by a second plurality of seismic sensors; interpolating, from the first measured seismic data, respective seismic data values at locations corresponding to respective sensors in the second plurality of seismic sensors; calculating a plurality of interpolation differences, where respective interpolation differences are determined as numerical differences between respective interpolated seismic data values corresponding to respective sensor locations in the second plurality of sensors and respective measured seismic data values corresponding to respective sensors in the first plurality of sensors; and calculating an average interpolation difference using at least the plurality of interpolation differences.

In accordance with some embodiments, a computer-readable storage medium is provided, the medium having a set of one or more programs including instructions that when executed by a computing system cause the computing system to obtain first measured seismic data acquired by a first plurality of seismic sensors; obtain second measured seismic data acquired by a second plurality of seismic sensors; interpolate, from the first measured seismic data, respective seismic data values at locations corresponding to respective sensors in the second plurality of seismic sensors; calculate a plurality of interpolation differences, where respective interpolation differences are determined as numerical differences between respective interpolated seismic data values corresponding to respective sensor locations in the second plurality of sensors and respective measured seismic data values corresponding to respective sensors in the first plurality of sensors; and calculate an average interpolation difference using at least the plurality of interpolation differences.

In accordance with some embodiments, a computing system is provided that includes at least one processor, at least one memory, and one or more programs stored in the at least one memory. The computing system further includes means for obtaining first measured seismic data acquired by a first plurality of seismic sensors, and means for obtaining second measured seismic data acquired by a second plurality of seismic sensors. The computing system may also include means for interpolating, from the first measured seismic data, respective seismic data values at locations corresponding to respective sensors in the second plurality of seismic sensors. The computing system may also include means for calculating a plurality of interpolation differences, where respective interpolation differences are determined as numerical differences between respective interpolated seismic data values corresponding to respective sensor locations in the second plurality of sensors and respective measured seismic data values corresponding to respective sensors in the first plurality of sensors. The computing system may also include means for calculating an average interpolation difference using at least the plurality of interpolation differences.

In some embodiments, the measured seismic data is in a frequency domain.

Some embodiments may cause the average interpolation difference to be displayed.

Some embodiments may determine respective time domain seismic data values at locations corresponding to respective sensors in the first plurality of seismic sensors and the second plurality of seismic sensors.

Some embodiments determine time domain seismic data values includes solving at least one convex optimization problem.

Some embodiments determine that the average interpolation difference exceeds a threshold, and obtain measured seismic data from a third plurality of seismic sensors.

Some embodiments obtain a data subset from the measured seismic data from the first plurality of seismic sensors and the measured seismic data from the second plurality of seismic sensors, and interpolate, from the data subset, interpolated seismic data values at a plurality of locations corresponding to respective sensors in the first plurality of seismic sensors and the second plurality of seismic sensors.

Some embodiments randomly select locations of respective sensors in the first plurality of seismic sensors. Some embodiments randomly select locations of respective sensors in the second plurality of seismic sensors.

In some embodiments, the average includes a sum of squares.

In some embodiments, locations of respective sensors in the first plurality of seismic sensors are disjoint from locations of respective sensors in the first plurality of seismic sensors.

Thus, the computing systems and methods disclosed herein are more effective methods for quality checking interpolated seismic survey data. These computing systems and methods increase data collection and processing effectiveness, efficiency, and accuracy. Such methods and computing systems may complement or replace conventional methods for quality checking interpolated seismic survey data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a seismic data acquisition plan in accordance with some embodiments.

FIGS. 2, 3, 4A, 4B, and 4C are flow diagrams illustrating methods of interpolation quality checking in accordance with some embodiments.

FIG. 5 illustrates a computing system in accordance with some embodiments.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

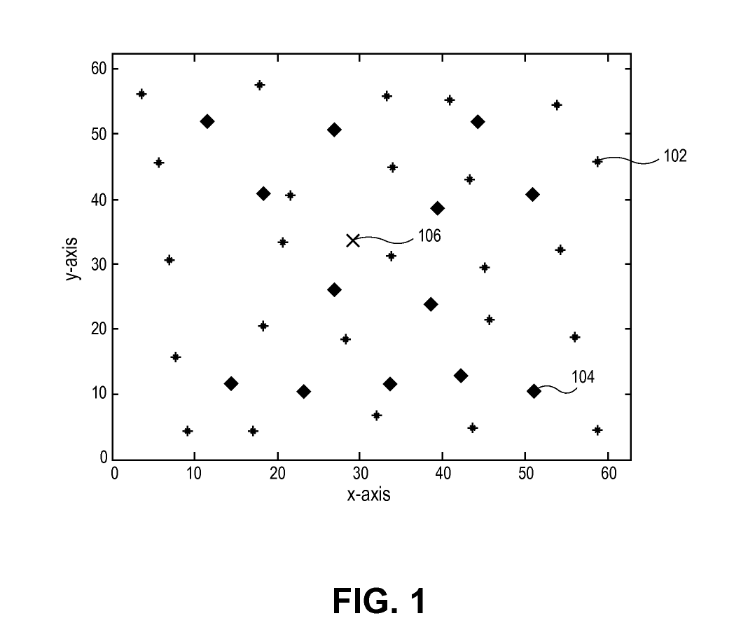

FIG. 1 illustrates a seismic survey data acquisition plan 100 in accordance with some embodiments. A goal of seismic surveying may be to build up an image of a survey area for purposes of identifying subterranean geological formations. Subsequent analysis of the representation may reveal probable locations of hydrocarbon deposits in subterranean geological formations, for example.

Plan 100 depicts the locations of seismic sensors, e.g., 102, 104. The x-axis and y-axis of plan 100 represent coordinates, scaled such that the plan may be conveniently presented on paper, but may represent a very large geographical area. According to plan 100, the seismic sensors may be non-uniformly, e.g., randomly, placed. Plan 100 may be for terrestrial seismic sensing, such that the locations represent seismic sensors positioned on or near to the surface of the Earth. In some embodiments, plan 100 may represent seismic sensing as performed over a body of water, such that the locations represent seismic sensors floating on or just under the surface of a body of water.

The seismic sensors may be, depending on the particular embodiment of the invention, capable of detecting a pressure wavefield associated with acoustic signals that are proximate to the sensors. The seismic sensors generate signals (digital signals, for example), called “traces,” which represent the acquired measurements of the reflected pressure wavefield. The sensors may include, for example, one or more geophones, hydrophones, particle displacement sensors, particle velocity sensors, accelerometers, pressure gradient sensors or combinations thereof.

One or more seismic sources 106, such as air guns, vibrators, explosives, and the like, are also associated with plan 100. The seismic sources may produce acoustic signals that are directed downward into geological strata. The acoustic signals may then reflect from the various subterranean geological formations. The incident acoustic signals that are generated by the seismic sources 106 produce corresponding reflected acoustic signals, or pressure waves, which may be sensed by the seismic sensors.

Representing and storing the traces in digital format (e.g., in the time domain, using a floating-point format, for individual sensors in a large seismic survey plan) may be practically intractable. Modern seismic data acquisition systems create huge amounts of data, at considerable storage cost. Sampling theory may generalize the sampling process to any linear measurement of the signal and, under certain circumstances, reduce the amount of data to be acquired and stored.

Accordingly, compressive sampling may be used to acquire and store data representing traces. Compressive sampling is based on the identification of a linear transform of the acquired data, such that acquisition and representation of the data in the transform domain may occupy less storage capacity than the capacity that might be employed for the actual measured data. In particular, data may be acquired in a domain other than the original time domain, e.g., a frequency domain. (The term “frequency” as used herein denotes both instances per time unit and instances per space unit, depending on context.) Computer algorithms may reconstruct time-domain data from the stored transform-domain data. Thus, those of skill in the art may utilize compressive sampling techniques for acquiring and storing seismic survey data in a manageable manner.

In more detail, compressive sampling may utilize the following equation.

\vec{d}=Mₛ\vec{r} (Equation 1)

In Equation 1, \vec{d} represents the data ordered sequentially in space and may be represented as \vec{d}^{T}=(d(\vec{x}₁), . . . , d(\vec{x}_{N})) with d(\vec{x}ₙ) denoting the data acquired at spatial sampling location \vec{x}ₙ. The matrix Mₛ represents the sensing matrix, i.e., the linear transformation between the domain in which the data has a compressible (e.g., sparse) representation, e.g., the frequency domain, and the actual data space, e.g., the temporal domain. The symbol \vec{r} represents a vector in the vector space of the sparse representations. The sensing matrix Mₛ depends on the actual sampling locations, i.e., the location of the seismic sensors in sampling space.

For one-dimensional spatial sampling, i.e. sampling along a line, as for example using a single streamer from a marine survey, the following may be used by way of non-limiting example. Those of ordinary skill understand how this example may be extrapolated to two dimensions. In this example, the linear transformation is the spatial Fourier transform; other transforms may be used in the alternative. The elements of the data vector may be computed from the Fourier spectrum contained in vector \vec{r}=(r_{-M/2}, . . . , r₀, . . . , r_{M/2}). The entries of this vector may include a complex number with the Fourier spectrum at wavenumber mΔk. This relationship may be represented as, by way of non-limiting example, the following.

$$d ( {x}_{n} ) = \frac{Δ k}{2 π} {\sum }_{m = - M / 2}^{M / 2} {r}_{m} {e}^{- i m Δ {kx}_{n}} \qquad ( Equation 2 )$$

The above may be combined into a system of equations like that of Equation 1, with matrix elements (mₛ (m,n)=e^{-mΔkx}^{ₙ}), m=−m/2, . . . , M/2, n=1, . . . , N. For seismic data, this representation may be used after a temporal Fourier transform of the recorded seismograms, that is, d(xₙ)=d(xₙ, f) depends on temporal frequency, as well as the spatial Fourier spectrum rₘ=rₘ (f). Further, the sensing matrix may be independent of temporal frequency. A variety of algorithms may be used to compute the original, e.g., temporal-domain, representation of the data, e.g., by solving the linear system of Equation 1 for \vec{r}. In particular, the system of Equation 1 may be solved using known convex optimization techniques.

Compressive sampling techniques may also be used to interpolate time-domain data from the compressed representation at arbitrary locations, not limited to the locations of the actual seismic sensors that acquired the time-domain data. This may be used to create interpolated data on a regular grid (e.g., a grid with uniformly spaced locations), for example, as opposed to the non-uniform sampling plan depicted in FIG. 1. The interpolation is based on the inverse to the linear transform that would have been used if the data would have been acquired in the interpolated locations.

Thus, data in the transform domain may be used for data interpolation, i.e. constructing data at non-sampling locations, e.g., locations not covered by data acquisition sensors. The interpolation process may not reconstruct the actual data as a first step. For the reconstruction at non-sampling locations, i.e., for actual interpolation, the sensing matrix Mₛ, which depends on the actual sampling locations \vec{x}ₙ, may be replaced in the reconstruction process by an alternative sensing matrix Mᵢ. The alternative sensing matrix Mᵢ may be the sensing matrix that would have been used if sensors 102, 104 were placed at the non-sampling locations \vec{y}ₘ. This may be represented as, by way of non-limiting example, Equation 3 below.

\vec{d}ᵢ=Mᵢ\vec{r}₀ (Equation 3)

In Equation 3, \vec{d}ᵢ is the data reconstructed at non-sampling locations \vec{y}ₘ, and Mᵢ is the alternative sampling matrix.

Interpolating seismic data values may introduce error relative to the data values that would have been measured at the interpolation locations. That is, an interpolated seismic data value at a particular location may differ from a measured seismic data value at the same location. However, there may not be a general technique for estimating interpolation error in seismic survey data. Some embodiments therefore present a technique that may estimate and quantify interpolation error in seismic survey data.

Accordingly, some embodiments use “witness” measurements at strategically placed locations in addition to the measurements collected at the sampling locations, which may be stored using the compressive sensing process. As such, the reconstructed data, generated without using the witness measurements in the data representation and reconstruction process, may be compared against the measured witness data. This may allow for a quantification of the interpolation error. In the data representation and reconstruction process, however, the witness data may be used as well, as this may further reduce the interpolation error.

In FIG. 1, sampling locations used for interpolation quality check purposes are marked with diamonds, e.g., for sensor location 104. The data measured at the locations marked with diamonds is estimated from the data measured at the star-marked locations, e.g., 102, such that the difference between measured data and the interpolated data may be used for interpolation quality checking purposes. More particularly, the sampling locations depicted by stars may be referred to as a “base” seismic survey data acquisition plan, and the sampling locations depicted by diamonds may be referred to as a “witness” seismic survey plan. Data may be measured according to both plans. The base survey plan may be used to interpolate seismic data values at locations of the witness survey plan. The differences between the measured and the interpolated seismic data values, e.g., in the temporal domain, may be calculated at the witness locations. These differences may be averaged, such that the overall interpolation error may be estimated. If the estimated interpolation error is in excess of a required interpolation error, more samples may be obtained, e.g., by placing additional sensors. Once the interpolation error is determined as being acceptable, the seismic data from the sensor locations from both the base and witness seismic survey data acquisition plans may be used to determine a final seismic survey.

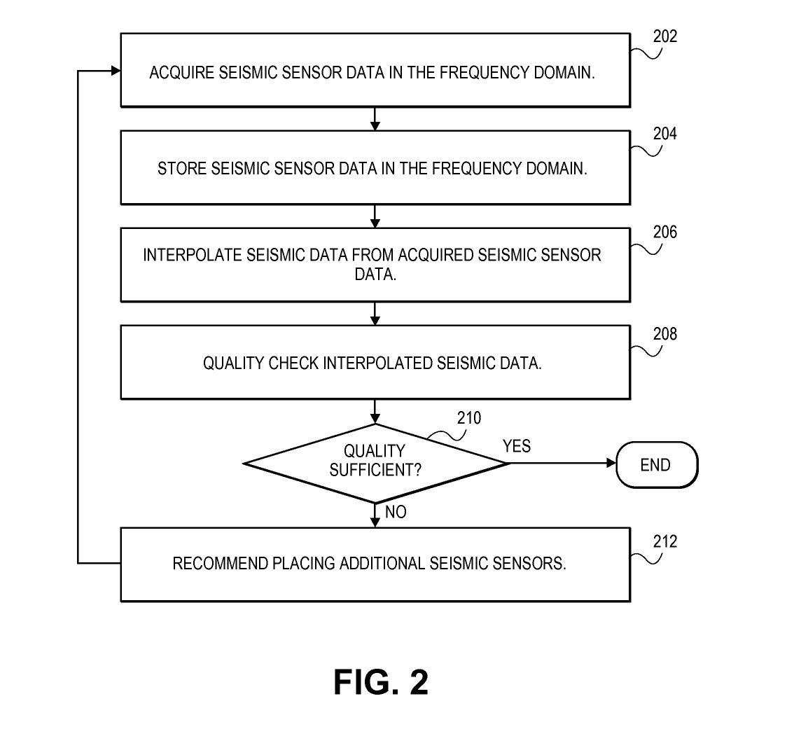

FIG. 2 illustrates a flow diagram of a method 200 of interpolation quality checking in accordance with some embodiments. The method 200 of FIG. 2 may be implemented in the context of a seismic survey plan, e.g., the plan 100, as shown and described above in reference to FIG. 1. For example, the method 200 may be implemented once seismic sensors are placed.

At block 202, seismic sensor data is acquired according to a base seismic survey data acquisition plan and a witness seismic survey data acquisition plan. The data may be acquired in a transform domain, such as a frequency domain. According to compressive sampling, the acquired data may be small enough that it may be stored (block 204) directly on persistent electronic memory, e.g., a hard disc drive. At block 206, seismic survey data is interpolated from the base survey plan at the locations of the seismic sensors of the witness survey plan. The interpolation may be according to compressive sampling interpolation as described above in reference to FIG. 1.

Next, at block 208, the interpolated seismic survey data is quality checked. This process may involve calculating in the temporal domain a difference, e.g., an absolute value of a numerical difference, between the measured data and the interpolated data for the respective locations in the witness seismic survey plan. These differences may be summed over at least a subset (e.g., all) locations in the witness seismic survey plan. The sum may then be divided by the number of locations in the witness seismic survey plan to arrive at an average interpolation error.

In some embodiments, the differences are squared prior to summing, such that the average interpolation error is calculated as an average of squares.

At block 210, a determination is made as to whether the average interpolation error is sufficiently small. To that end, some embodiments may include a threshold, such that if the average interpolation error exceeds the threshold, then the interpolation error may be deemed excessive. In such case, the interpolation may be considered to have failed the quality check, and control may be passed to block 212. If the average interpolation error is below the threshold, then the interpolation error may be deemed acceptable, the interpolation may be considered to have passed the quality check, and the process may be complete. Some embodiments permit a user to specify a threshold using, e.g., a graphical user interface.

At block 212, the method 200 may include providing a recommendation to place additional seismic sensors. In general, the more seismic sensors in a seismic survey data acquisition plan, the more accurate the measurements, and the smaller interpolation error. Accordingly, after additional seismic sensors are placed, the method 200 may return to block 202, in which seismic survey data is again acquired. In general, the process may continue until the interpolation error is deemed acceptable and the interpolation passes the quality check.

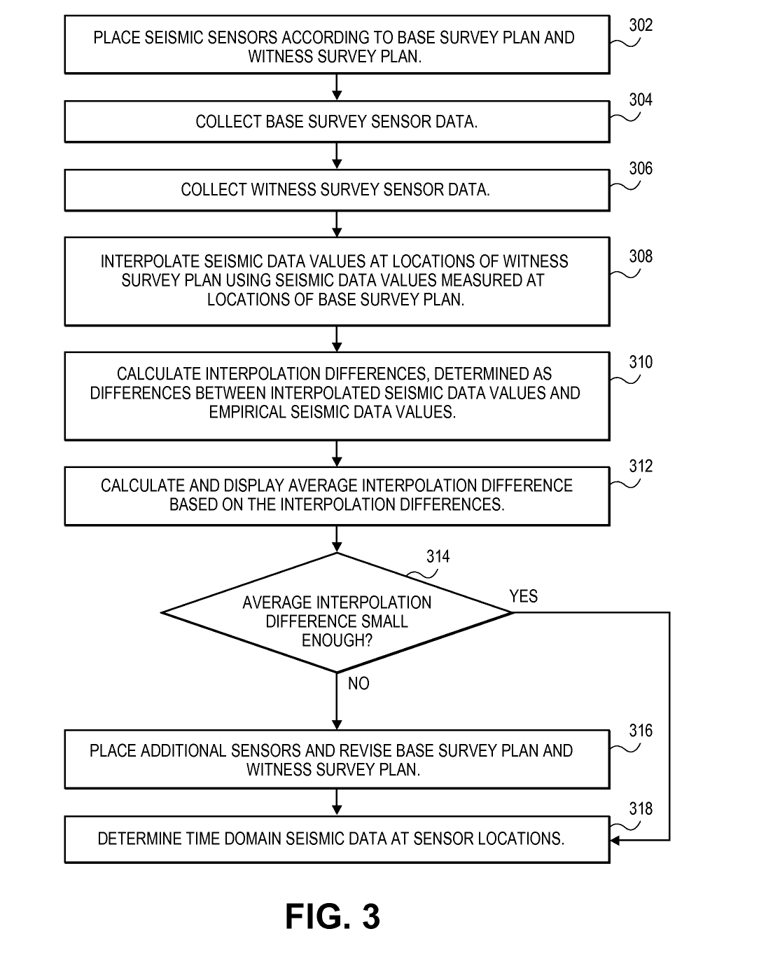

FIG. 3 illustrates a flow diagram of a method 300 of interpolation quality checking in accordance with some embodiments. At block 302 of method 300, seismic sensors may be placed according to a base seismic survey data acquisition plan and according to a witness seismic survey data acquisition plan. As described above in reference to FIG. 1, the sensors may be terrestrial or marine, for example. In some embodiments, the sensor locations of the base seismic survey data acquisition plan are disjoint from the sensor locations of the witness seismic survey data acquisition plan. That is, in some embodiments, the same location does not appear on both seismic survey data acquisition plans. In some embodiments, the seismic sensors are non-uniformly, e.g., randomly, placed.

At block 302, the process collects base seismic survey sensor data from the sensors placed according to the base seismic survey data acquisition plan. The base seismic survey data may be collected in a transform domain such as a frequency domain, for example, in embodiments that utilize compressive sampling. The base seismic survey data may be stored in persistent memory.

At block 306, the process collects witness seismic survey sensor data from the sensors placed according to the witness seismic survey data acquisition plan. The witness seismic survey data may be collected in a transform domain such as a frequency domain, for example, in embodiments that utilize compressive sampling. The witness seismic survey data may be stored in persistent memory.

At block 308, the process interpolates seismic data values at locations of the witness seismic survey data acquisition plan based in the measured seismic data values at locations of the base seismic survey data acquisition plan.

At block 310, the process calculates interpolation differences. The respective interpolation differences may be calculated as absolute values of numerical differences, e.g., using subtraction, between an interpolated seismic data value and a measured seismic data value at the locations of the witness seismic survey data acquisition plan.

At block 312, the process calculates the average interpolation difference based on the individual interpolation differences determined at block 310. The average may be a simple average, that is, a sum divided by the number of terms in the sum. In some embodiments, the average interpolation difference includes a sum of squares. In such embodiments, the average interpolation difference may be calculated as the sum of squares of differences between interpolated seismic data values and measured seismic data values, divided by the number of such squared terms.

At block 314, the process determines whether the average interpolation difference is sufficiently small. This may be accomplished by comparing the average interpolation difference to a threshold, which may be set by a user. The threshold may be selected to ensure that the interpolation error is within an amount that would permit hydrocarbon acquisition if the borehole were placed within the interpolation error distance from its intended location. If the average interpolation difference is sufficiently small, then control passes to block 318. Otherwise, if the average interpolation difference is not small enough, then control passes to block 316.

At block 318, the process determines time-domain seismic data at locations of the seismic sensors in both the base seismic survey data acquisition plan and the witness seismic survey data acquisition plan. The determination may include solving a convex optimization problem using known techniques, e.g., if relying on a compressive sampling implementation.

If the process branches to block 316 from block 314, then the process includes placing additional sensors and revising the base seismic survey data acquisition plan and the witness seismic survey data acquisition plan. From block 316, control passes back to block 304.

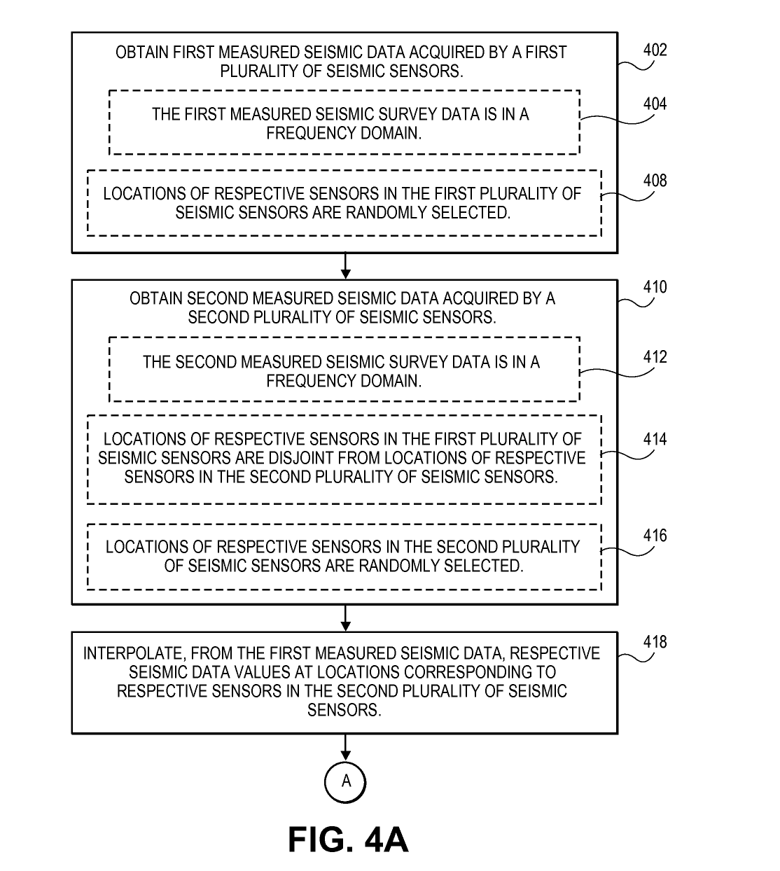

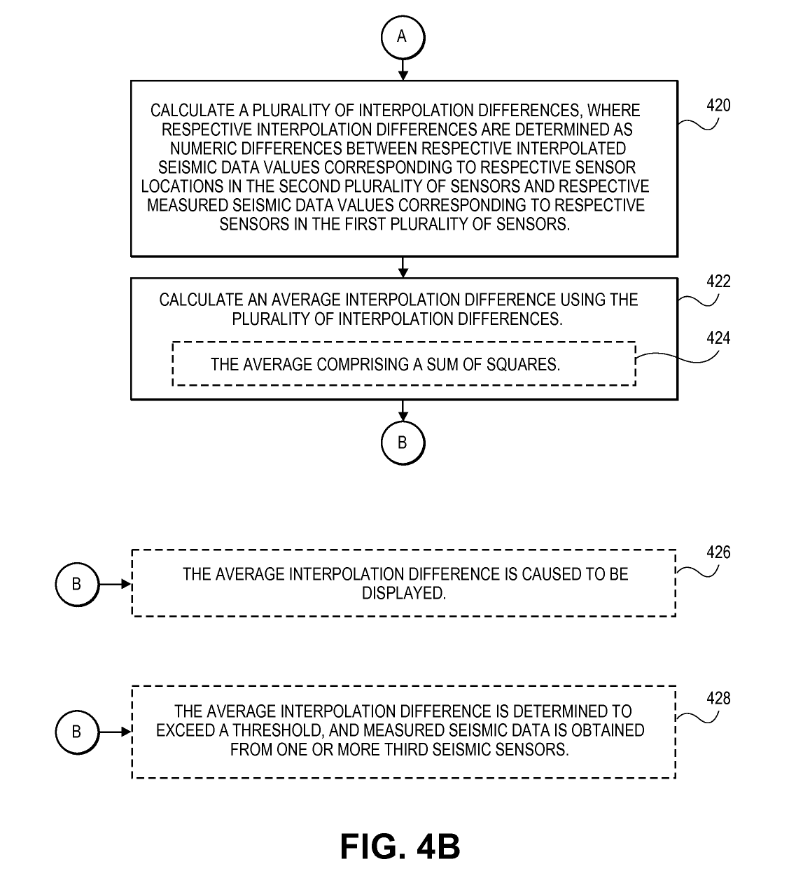

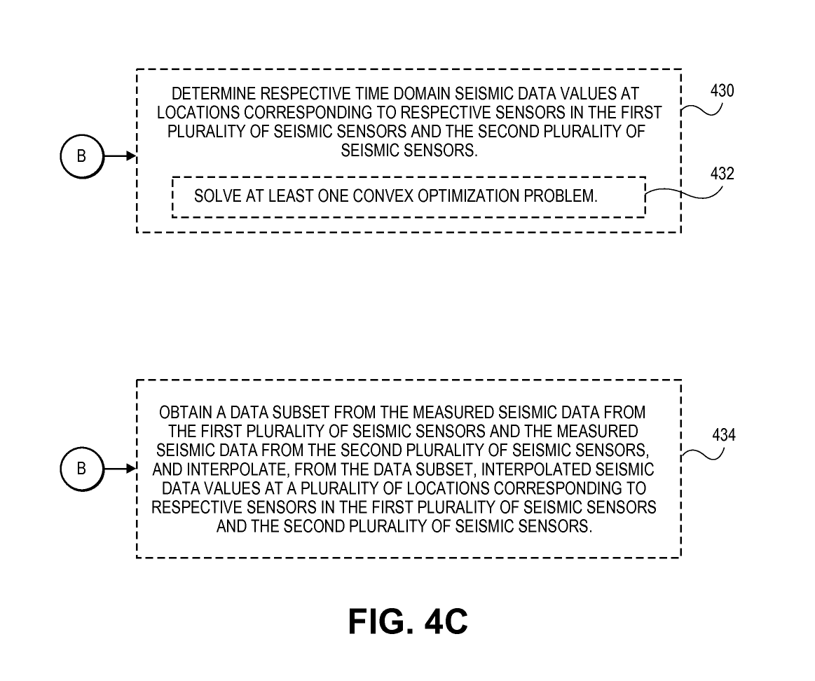

FIGS. 4A, 4B and 4C illustrate a flow diagram of a method 400 of interpolation quality checking in accordance with some embodiments. The method 400 may include obtaining first measured seismic data acquired by a first plurality of seismic sensors (e.g., FIG. 2, 202, acquiring seismic sensor data in the frequency domain, and FIG. 3, 304, collect base survey sensor data). In an embodiment, the first measured seismic survey data may be in a frequency domain, as at 404 (e.g., FIG. 2, 202, acquiring seismic sensor data in the frequency domain). Yet further, in an embodiment, the locations of respective sensors in the first plurality of seismic sensors are randomly selected, as at 408 (e.g., FIG. 3, 302, place seismic sensors according to base survey plan and witness survey plan). It will be appreciated, however, that embodiments that omitting any of blocks 404 and/or 408 is specifically contemplated herein.

The method 400 may also include obtaining second measured seismic data acquired by a second plurality of seismic sensors (e.g., FIG. 2, 202, acquiring seismic sensor data in the frequency domain, and FIG. 3, 306, collect witness survey sensor data). In an embodiment, the second measured seismic survey data may be in a frequency domain, as at 412 (e.g., FIG. 2, 202, acquiring seismic sensor data in the frequency domain). Further, in an embodiment, the locations of the respective sensors in the second plurality of seismic sensors are disjoint from locations of respective sensors in the first plurality of seismic sensors, as at 414 (e.g., FIG. 3, 302, place seismic sensors according to base survey plan and witness survey plan). Yet further, in an embodiment, the locations of respective sensors in the second plurality of seismic sensors are randomly selected, as at 416 (e.g., FIG. 3, 302, place seismic sensors according to base survey plan and witness survey plan). It will be appreciated, however, that embodiments that omit any of blocks 412, 414, and/or 416 are specifically contemplated herein.

The method 400 may also include interpolating, from the measured seismic data, respective seismic data values at locations corresponding to respective sensors in the second plurality of seismic sensors, as at 418 (e.g., FIG. 2, 206, interpolate seismic data from acquired seismic sensor data, FIG. 3, 308, interpolate seismic data values at locations of witness survey plan using seismic data values measured at locations of base survey plan).

The method 400 may also include calculating a plurality of interpolation differences, where respective interpolation differences are determined as numerical differences between respective interpolated seismic data values corresponding to respective sensor locations in the second plurality of sensors and respective measured seismic data values corresponding to respective sensors in the first plurality of sensors, as at 420 (e.g., FIG. 3, 310, calculate interpolation differences, determined as differences between interpolated seismic data values and empirical seismic data values).

The method 400 may also include calculating an average interpolation difference using at least the plurality of interpolation differences, as at 422 (e.g., FIG. 3, 312, calculate average interpolation difference based on the interpolation differences). In an embodiment, the average may comprise a sum of squares, as at 424.

After block 422, the process 400 may include any, or a combination, of several additional actions 426, 428, 430, 432, 434. It will be appreciated, however, that embodiments that omit any of blocks 412, 414, and/or 416 are specifically contemplated herein.

Thus, the method 400 may include causing the average interpolation difference to be displayed, as at 226 (e.g., FIG. 3, 312, calculate and display average interpolation difference based on the interpolation differences).

The method 400 may include determining that the average interpolation difference exceeds a threshold, and, when the average interpolation difference exceeds the threshold, obtaining measured seismic data from a third plurality of sensors, as at 428 (e.g., FIG. 2, 212, place additional seismic sensors, FIG. 3, 316, place additional sensors and revise base survey plan and witness survey plan).

The method 400 may also determine respective time domain seismic data values at locations corresponding to respective sensors in the first plurality of seismic sensors and the second plurality of seismic sensors, as at 430 (e.g., FIG. 3, 318, determined time domain seismic data at sensor locations). This may include solving at least one convex optimization problem, as at 432 (e.g., FIG. 3, 318, determined time domain seismic data at sensor locations).

The method 400 may also obtain a data subset from the measured seismic data from the first plurality of seismic sensors and the measured seismic data from the second plurality of seismic sensors, and interpolate, from the data subset, interpolated seismic data values at a plurality of locations corresponding to respective sensors in the first plurality of seismic sensors and the second plurality of seismic sensors, as at 434.

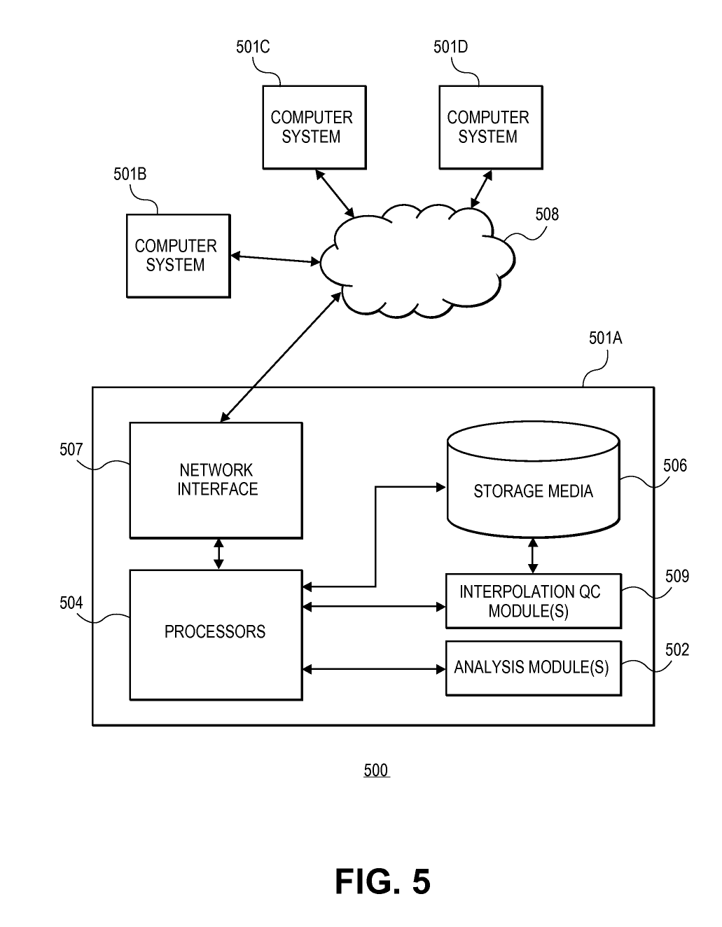

FIG. 5 illustrates an example computing system 500A in accordance with some embodiments. The computing system 500A may be an individual computer system 504A or an arrangement of distributed computer systems. The computer system 504A includes one or more analysis modules 502 that are configured to perform various tasks according to some embodiments, such as one or more methods disclosed herein (e.g., methods 200, 300 and 400, and/or combinations and/or variations thereof). To perform these various tasks, analysis module 502 executes independently, or in coordination with, one or more processors 504, which is (or are) connected to one or more storage media 506A. The processor(s) 504 is (or are) also connected to a network interface 507 to allow the computer system 501A to communicate over a data network 508 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be on a laboratory, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506A may be implemented as one or more computer-readable or machine-readable storage media. Note that while in the example embodiment of FIG. 5 storage media 506A is depicted as within computer system 501A, in some embodiments, storage media 506A may be distributed within and/or across multiple internal and/or external enclosures of computing system 501A and/or additional computing systems. Storage media 506A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BluRays, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more interpolation QC module(s) 509. In the example of computing system 500, computer system 501A includes interpolation QC module 509. In some embodiments, a single interpolation QC module may be used to perform some or all aspects of methods 200, 300 and 400. In alternate embodiments, a plurality of interpolation QC modules may be used to perform some or all aspects of methods 200, 300 and 400.

It should be appreciated that computing system 500A is only one example of a computing system, and that computing system 500A may have more or fewer components than shown, may combine additional components not depicted in the example embodiment of FIG. 5, and/or computing system 500A may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer implemented method for quality checking seismic interpolation data, the method comprising:
obtaining first measured seismic data acquired by a first plurality of seismic sensors;
obtaining second measured seismic data acquired by a second plurality of seismic sensors;
interpolating, from the first measured seismic data, respective seismic data values at locations corresponding to respective sensors in the second plurality of seismic sensors;
calculating a plurality of interpolation differences, wherein respective interpolation differences are calculated as numerical differences between respective interpolated seismic data values corresponding to respective sensor locations in the second plurality of sensors and respective measured seismic data values corresponding to respective sensors in the first plurality of sensors; and
calculating an average interpolation difference using at least some of the plurality of interpolation differences.

2. The method of claim 1, wherein the first measured seismic data and the second measured seismic data are in a frequency domain.

3. The method of claim 1, further comprising causing the average interpolation difference to be displayed.

4. The method of claim 1, further comprising determining respective time domain seismic data values at locations corresponding to respective sensors in the first plurality of seismic sensors and the second plurality of seismic sensors.

5. The method of claim 4, wherein determining time domain seismic data values comprises solving at least one convex optimization problem.

6. The method of claim 1, further comprising:
when the average interpolation difference exceeds a threshold, obtaining measured seismic data from a third plurality of seismic sensors.

7. The method of claim 1, further comprising:
obtaining a data subset from the measured seismic data from the first plurality of seismic sensors and the measured seismic data from the second plurality of seismic sensors; and
interpolating, from the data subset, interpolated seismic data values at a plurality of locations corresponding to respective sensors in the first plurality of seismic sensors and the second plurality of seismic sensors.

8. The method of claim 1, further comprising:
randomly selecting locations of respective sensors in the first plurality of seismic sensors.

9. The method of claim 1, further comprising:
randomly selecting locations of respective sensors in the second plurality of seismic sensors.

10. The method of claim 1, wherein the average comprises a sum of squares.

11. The method of claim 1, wherein locations of respective sensors in the first plurality of seismic sensors are disjoint from locations of respective sensors in the second plurality of seismic sensors.

12. A computing system, comprising:
one or more processors; and
a memory system comprising one or more computer-readable media storing instructions thereon that, when executed by the one or more processors, are configured to cause the computing system to perform operations, the operations comprising:
obtaining first measured seismic data acquired by a first plurality of seismic sensors;
obtaining second measured seismic data acquired by a second plurality of seismic sensors;
interpolating, from the first measured seismic data, respective seismic data values at locations corresponding to respective sensors in the second plurality of seismic sensors;
calculating a plurality of interpolation differences, wherein respective interpolation differences are calculated as numerical differences between respective interpolated seismic data values corresponding to respective sensor locations in the second plurality of sensors and respective measured seismic data values corresponding to respective sensors in the first plurality of sensors; and
calculating an average interpolation difference using at least some of the plurality of interpolation differences.

13. The computing system of claim 12, wherein the first measured seismic data and the second measured seismic data are in a frequency domain.

14. The computing system of claim 12, wherein the operations further comprise causing the average interpolation difference to be displayed.

15. The computing system of claim 12, wherein the operations further comprise determining respective time domain seismic data values at locations corresponding to respective sensors in the first plurality of seismic sensors and the second plurality of seismic sensors.

16. The computing system of claim 15, wherein determining time domain seismic data values comprises solving at least one convex optimization problem.

17. The computing system of claim 12, wherein the operations further comprise:
when the average interpolation difference exceeds a threshold, obtaining measured seismic data from a third plurality of seismic sensors.

18. The computing system of claim 12, wherein the operations further comprise:
obtaining a data subset from the measured seismic data from the first plurality of seismic sensors and the measured seismic data from the second plurality of seismic sensors; and
interpolating, from the data subset, interpolated seismic data values at a plurality of locations corresponding to respective sensors in the first plurality of seismic sensors and the second plurality of seismic sensors.

19. The computing system of claim 12, wherein the operations further comprise:
randomly selecting locations of respective sensors in the first plurality of seismic sensors.

20. The computing system of claim 12, wherein the operations further comprise:
randomly selecting locations of respective sensors in the second plurality of seismic sensors.

21. The computing system of claim 12, wherein the average comprises a sum of squares.

22. The computing system of claim 12, wherein locations of respective sensors in the first plurality of seismic sensors are disjoint from locations of respective sensors in the second plurality of seismic sensors.
